(19) United States
(12) Patent Application Publication
(10) Pub. No.: US 2013/0078963 A1
(43) Pub. Date: Mar. 28, 2013

(54) Method and Apparatus for Incoming Call Filtration and Message Delivery

(71) Applicants: Krishnaswamy Venkatesh Prasad, Ann Arbor, MI (US); David L. Watson, Ann Arbor, MI (US); Thomas J. Giuli, Ann Arbor, MI (US)

(72) Inventors: Krishnaswamy Venkatesh Prasad, Ann Arbor, MI (US); David L. Watson, Ann Arbor, MI (US); Thomas J. Giuli, Ann Arbor, MI (US)

(73) Assignee: FORD GLOBAL TECHNOLOGIES, LLC, Dearborn, MI (US)

(21) Appl. No.: 13/242,497

(22) Filed: Sep. 23, 2011

(51) Int. Cl. H04W 4/04

(52) U.S. Cl. 455/414.1

(57) ABSTRACT

A computer-implemented method includes detecting an incoming call to a wireless device in communication with a vehicle computing system (VCS). The method further includes determining that a do not disturb (DND) feature is enabled on the VCS and comparing one or more aspects of the incoming call to one or more filters of the DND feature to determine user notification eligibility. The method also includes notifying the user, through the VCS, of the incoming call, conditional on the eligibility of the call.

### TECHNICAL FIELD

The illustrative embodiments generally relate to methods and apparatus for incoming call filtration and message delivery.

### BACKGROUND

Nearly every person in America beyond a certain age owns a cellular phone (smart phone, pda, etc.). Wireless phones have all but replaced land lines in many households, and even children are being given cellular phones to keep in touch with friends and parents. While using a cellular phone is, in most cases, a generally safe concept, recent concern has arisen over the growing number of accidents resulting from vehicle drivers using their phones.

Certain states have addressed this problem by passing laws prohibiting usage of a phone (at least directly) while driving a vehicle. Other states prohibit text messaging while driving, as text messaging almost ensures that a driver will not be focused on the road. Hands-free alternatives to phones can be installed in vehicles. These options typically provide the ability to handle phone calls while allowing the driver to focus on the task of driving.

Even with hands free alternatives, however, drivers may still not wish to be disturbed while driving. Times of high traffic, distractions by children or dangerous driving conditions may require a driver's full focus, and thus it may be desirable to ignore or prohibit calls from being placed to a driver. Today, at least in some hands-free systems, such as that provided by the FORD SYNC system, drivers can block incoming phone calls by enabling a do-not-disturb feature such as that shown in Prior Art FIG. 2.

In this illustrative example of an existing system, an incoming call signal is received at the vehicle (typically transferred from a phone) 201. If the do not disturb (DND) option is active, the system may simply block the incoming call event 207. Otherwise, a notification about the call may be presented 203. If the call is blocked, the driver will likely not even know the call came through, until a later time when, for example, a voice message associated with the call is received and reviewed.

### SUMMARY

In a first illustrative embodiment, a computer-implemented method includes detecting an incoming call to a wireless device in communication with a vehicle computing system (VCS). The method further includes determining that a do not disturb (DND) feature is enabled on the VCS and comparing one or more aspects of the incoming call to one or more filters of the DND feature to determine user notification eligibility. The method also includes notifying the user, through the VCS, of the incoming call, conditional on the eligibility of the call.

In a second illustrative embodiment, a computer implemented method includes detecting an incoming call to a wireless device in communication with a vehicle computing system (VCS). The method further includes permitting hands-free answering of the call through the VCS and evaluating driver behavior during the call.

Also, the method includes storing a plurality of environmental factors existent during the call, conditional on the results of the evaluating. The method additionally includes analyzing stored environmental factors and, resultant on the analyzing, recommending one or more rules for call filtering.

In a third illustrative embodiment, a computer-implemented method includes transmitting vehicle GPS coordinates from a vehicle computing system (VCS) to a remote server. The method also includes receiving one or more legally required call filters from the remote server and implementing the one or more legally required call filters in a do not disturb system. The method further includes enabling the do not disturb system.

### BRIEF DESCRIPTION OF THE DRAWINGS

FIG. 1 shows an illustrative example of a vehicle computing system;

FIG. 2 shows an illustrative example of a prior art do not disturb process;

FIG. 3 shows an illustrative example of a call filtration process;

FIG. 4 shows an illustrative example of a rule suggestion process;

FIG. 5 shows an illustrative example of a rule update process;

FIG. 6 shows an illustrative example of a message delivery process;

FIG. 7 shows an illustrative example of a state diagram for a filtration/message delivery system; and

FIG. 8 shows an illustrative example of a rule development process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

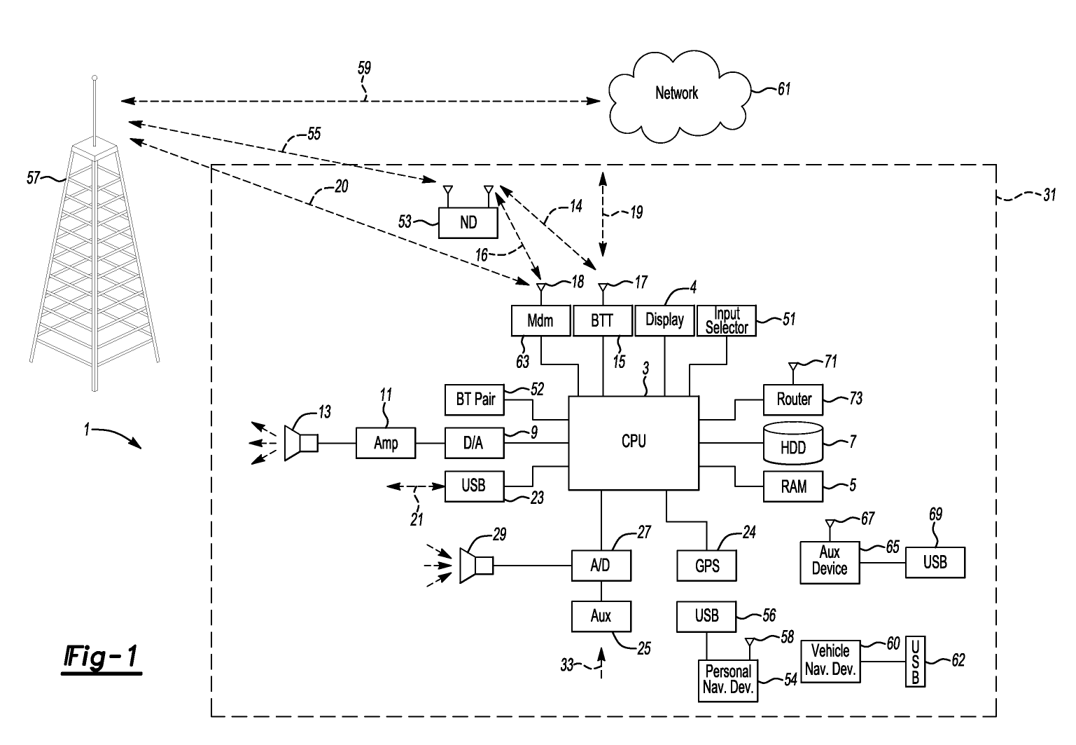

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users.

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In at least some current models of DND features, the DND option is an all or nothing option. In other words, either all calls pass through or no calls pass through. While this option is suitable for preventing driver distraction, it may be desirable for certain calls to get through even if DND is actively set (e.g., without limitation, babysitter, work, work during work hours, hospital, etc.).

Additionally, DND is actively set by a driver whenever call blocking/filtration is desired. There may be conditions, however, under which it would be advisable or desirable for DND to be enabled, and it may simply not occur to the driver to turn the feature on. Alternatively, or additionally, it may be the case that certain laws require DND or filtration to be active during certain hours or periods of high traffic.

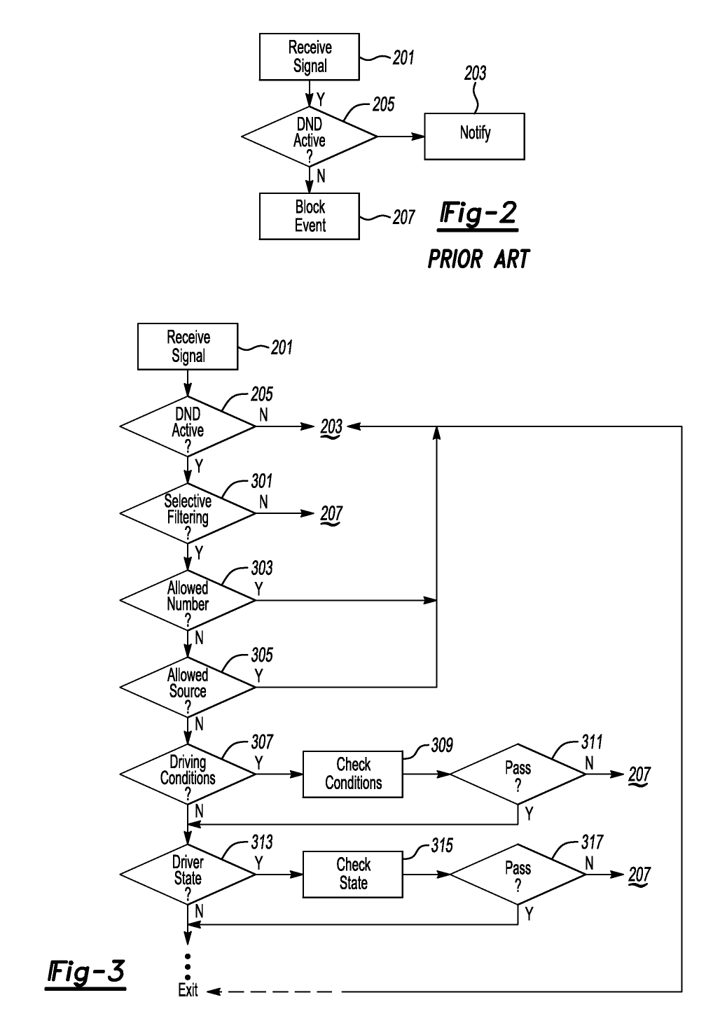

FIG. 3 shows an illustrative example of a call filtration process. In this illustrative example, an incoming call signal is received 201. The process first checks to see if DND is disabled 205. If DND is not active, then there should be no filtration of calls and the notification regarding the call is permitted 203.

If DND is active, the process checks to see if selective filtration is active 301. In selective filtration mode, one or more filters has been applied to determine if particular calls should get through based on characteristics associated with those calls. If there is no selective filtration active, then DND is set to block all calls and the notification event is blocked 207. If selective filtration is enabled, then the process proceeds to a next step.

With selective filtration enabled, a driver is able to pre-arrange one or more conditions under which a call is blocked/allowed. For example, the driver could preset a system to always deliver calls from work during work hours, and always block calls from work during non-work hours. Work hours could also be defined by the driver when the rule is set up.

Also, the driver could always allow calls from a spouse, even if DND is enabled, or from, for example, a medical facility where a family member is currently staying. Filters could be set using a vehicle interface associated with a DND function, or they could be set on a phone application or remote website and transferred to a vehicle for use.

Calls can also be filtered by number or source. For example, a person could designate a particular number (such as a work number) for pass-through at certain times of day (or always). In other instances, the person may wish to allow all calls from a particular entity. For example, if John Smith had four phone numbers associated therewith in an address book, and the person wanted to allow calls from John Smith, it may be easier to simply designate the name of the caller than it would be to enter and associate all four numbers with a filter.

In the process shown in FIG. 3, the system determines if the incoming number corresponds to an allowed number 303 or source 305. If either pass-through limitation is met, then the call is an approved call to ignore DND and the notification process continues 203.

In this example, after allowed names and numbers are checked, DND is also checked for other conditions under which calls may be blocked. Since road conditions can change dynamically and unpredictably, a person may wish to have calls blocked when driving conditions exceed certain safety thresholds. For example, without limitation, if a vehicle is traveling faster than a certain speed, if a vehicle is in an area of high traffic, or if rain or snow is making driving dangerous, the driver may not wish to receive an incoming call.

On the other hand, if none of these conditions are met, then the driver may not wish to filter calls at all. In this example, the driver has preset a number of driving conditions under which calls are to be blocked 307. If this feature is enabled, the process checks current conditions (using local and/or cloud based sources) to see if any block conditions exist 309. If the condition check “passes” (i.e., no block conditions) then the process continues to other condition checks, since the driver is in a driving condition under which calls are allowed. Otherwise, the process blocks the call 207, since an unsafe condition exists.

In addition to driving conditions, numerous other factors for call blocking may also exist. In this example, the car may be outfitted with one or more biometric sensors. These sensors may be enabled to determine, with at least some degree of accuracy, a driver's general mental state. If the driver is in a state of high stress, for example, it may be desirable to block incoming calls. These options can be pre-configured by the driver, just as with the driving condition options.

If driver state checks are enabled 313, the process may proceed to check the state of a driver 315. If there is no state under which calls are to be blocked 317, the process may then proceed to check other conditions. If, however, the process detects that a driver is in, for example, a stressful state under which calls are to be blocked 317, then the process may block an incoming call 207.

Numerous other additional factors can also be included to block/allow calls. Once all factors have been considered and “passed” the process may proceed to allow a call 203. Since different drivers may have different priorities, it could also be possible to re-arrange the order in which rules are considered based on driver priorities. For example, if a driver wanted to receive no calls during dangerous driving conditions (for example, a teen driver), then the driving condition test could be made first. This way, even “allowed” numbers and sources could be blocked.

Or, for example, if no one but a parent were allowed to call in such conditions, the test could first be made for a single allowable source (the parent), then a test for conditions could be made, then a test for other allowable numbers (if other selective DND was enabled). By allowing a user to customize and prioritize filtering, filters designed exactly for a particular driver's needs can be set up in any given situation.

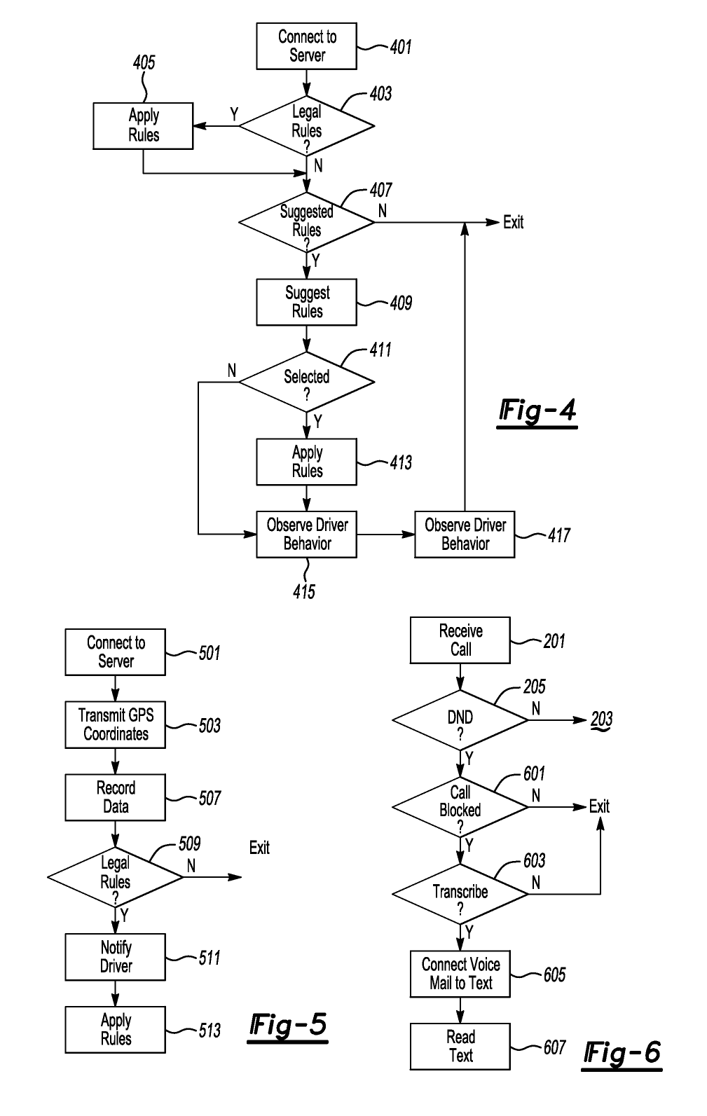

FIG. 4 shows an illustrative example of a rule suggestion process. This process takes several possible elements into consideration, and could be broken into multiple separate processes if needed. Since local governments are constantly regulating phone usage while in a vehicle, it may be the case that they begin to selectively monitor hands free usage as well. For example, phone usage may be completely prohibited during times/areas of high traffic or dangerous conditions. Systems that cannot filter for this may be prohibited or restricted, and it may be useful to have a system that can be selectively enabled/disabled according to regulations.

Additionally or alternatively, drivers may not even be aware of certain recommended or suggested filters that can be applied. This process can also provide some suggested filters, tailored to a certain driver, that could be applied.

In this example, the process connects to a remote server where required/suggested rules may be stored for distribution 401. In this example, it is assumed that there is the possibility of one or more legally mandated rules for a hands-free call filtration process. Accordingly, the process checks the server to see if any mandated rules exist 403. If there are legally mandated rules to be applied that have not previously been implemented 403, the process applies those rules to the filtration process.

If there are not any legal rules, or once the legal rules have been applied, the process checks to see if there any suggested rules 407. Suggested rules can be generally suggested rules, or they may even be rules that have been developed for a particular driver based on observations made by vehicle systems.

If there are any suggested rules 407, the process may suggest the particular rules to a driver 409 in, for example, a selectable or opt-in manner. If the driver elects some or all of the rules 411, then the rules may be applied to the filtration process 413. Additionally or alternatively, the VCS may be capable of automatically editing rules according to recognized driver preferences. For example, if a driver typically has DND enabled from 5:00-6:30 but disables it from 5:45-6:00 frequently (or always), the system may adaptively edit the rule based on observed behavior. This editing may or may not come with a notification to the driver and/or a request to make the change.

FIG. 5 shows an illustrative example of a rule update process. One danger a driver always faces when traveling in a new area is not knowing the laws that relate to, for example, cellular phone use in that area. Since cell-phone bans are not always clearly posted, drivers may continue to use phones in new areas, oblivious to the prohibitions against phone usage.

In this example, it is contemplated that regional hands-free phone rules may apply. This illustrative process periodically (or when a new area is encountered) connects to a remote server 501 and transmits vehicle GPS coordinates 503. Based on the transmitted coordinates, the server can determine if any particular legal rules apply for the area where the vehicle is currently traveling. If rules do apply, they can be sent from the server and received by the process 507.

If there are no legal rules associated with the area 509, the process may simply exit. If, however, certain legal rules apply, the system may notify the driver that a rule is being applied 511 and provide the driver with a summary of the rule. The rule can even be tied to GPS coordinates, or boundaries, such that it is only applied when the driver is traveling in a predefined area. The particular rule or rules are then applied to the system to keep the driver compliant with the local laws.

FIG. 6 shows an illustrative example of a message delivery process. In this illustrative example, the vehicle computing system VCS has a process for delivering information relating to missed calls in a relatively un-distracting manner for a driver. To the extent that vehicle settings permit it, the process can transcribe voicemails into text, and the text can then be read to a driver, so that the driver knows the content of missed calls. This delivery can occur once the message is left, or it can occur, for example, once a DND period has ended. Filters can also be set up for message delivery, similar to filters for blocking calls (e.g., some come straight through, some wait, etc.).

In this illustrative process, the system receives a call from a remote source 201 and checks 205 to see if a DND process is active. If the process is active, and if the process results in a blocked call 601 (due to, for example, a call not clearing the DND filters), the process then determines if a voicemail left with the call should be transcribed 603.

Since only some callers may have their voicemails transcribed, according to rules, the process will exit if the voicemail is not eligible for transcription. If the transcription occurs, however, the voicemail is converted to a text message 605 and, if desired/allowed, read back to a driver over, for example, a vehicle audio system 607. As previously noted, the read-back may occur at the time the message was left/transcribed, or at a later point in time when DND filters have been disabled.

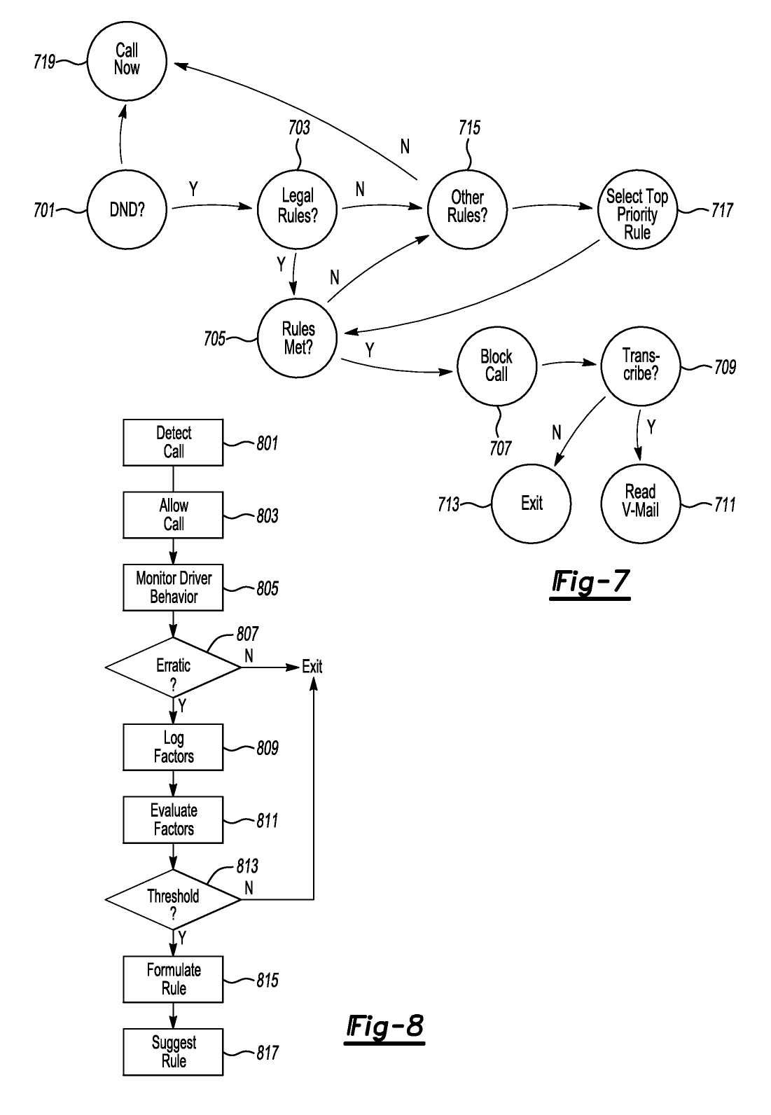

FIG. 7 shows an illustrative example of a state diagram for a filtration/message delivery system. In this illustrative example, a system with DND filtration (both legal and personalized) is enabled. The exemplary filters are “block” type filters, such that if the rules are met, a block occurs. Prioritization is given first to legally mandated rules, and then to driver implemented rules.

First, the system will determine if a DND process is even active at a particular time 701. If the process is not active, the system branches to an “allow call” state 719, since no filters exist to block the incoming call.

If the DND process is active, however, the process checks to see if there are any legal rules associated with the system 703. If there are legal rules that exist, they will be given priority in terms of determining whether a given call is to be blocked, to keep the user in compliance with legally mandated conditions.

If legal rules exist, the system checks to see if any of those rules apply 705. If any of the rules is “met” (e.g., in this example, if a block is to occur) the system proceeds to a block call state 707. From the block call state, if a voicemail is left, it is determined whether or not the voice mail is to be transcribed 709. A “yes” results in transcription and read-back state enablement 711, a “no” results in the process exiting.

If there are no legal rules, or if all legal rules have not been met (e.g., in this example, if there is no legal reason to block a call), the system checks for other user-initiated rules 715. If any rules exist, a top priority rule from those rules is selected 717 and considered 705. As with the legal rules, if the rule is met, the call is blocked. Otherwise, the system returns to check for remaining, untested rules 715. This looping process can continue until all rules are considered in order of priority. At any time, if a rule is “met” the call is blocked, but if all rules are considered and none is met, the call is allowed 719.

As noted, the rules in this example were blocking rules, which would prevent a call if met. This was done to aid in the simplicity of presenting the state diagram and was not intended to be limiting. It is also possible to have allowing rules, under which a call is allowed if the conditions set forth are met (and, possibly, all calls not meeting an allowing rule are then blocked).

FIG. 8 shows an illustrative example of a rule development process. Often times, a driver may not even realize when it may be appropriate to apply a particular rule. Since vehicle computing systems have the capacity for, and the capacity to access, complex and comprehensive analytics, it may be possible to develop rules customized for a particular driver based on driver behavior.

This could be useful in several situations. For example, if a new driver (e.g., teen) or an employee using a VCS equipped vehicle had just begun driving the vehicle, it may be desirable to develop rules that help ensure the safety of the vehicle occupants.

In this example, the process detects that an incoming call has been received 801, and allows the call to continue 803. While the call is in progress, one or more vehicle systems can be monitored to evaluate driver behavior during the call 805. This behavior can be compared to an observed baseline for that driver, or to a predefined baseline of appropriate driving behavior.

If the driver's behavior appears erratic 807, the process can log the factors relating to the particular incident (e.g., without limitation, driving speed, time of day, traffic, weather, particular caller, etc.). These factors can then be evaluated in the cloud, by the vehicle and/or immediately or at a later time 811.

Since it may be difficult to gauge what conditions caused the erratic behavior, each of the contributing factors may be given some value for a particular incident. Individually or in combination, these factors may be evaluated to determine if a threshold (indicating a high probability of erratic driving) has been passed 813.

For example, if the weather was rainy, the driver was traveling at 45 m.p.h. and there was medium traffic, and the caller was Jane Doe then for that call each factor (weather, speed, traffic, caller) may be assigned some value. These values can then be added to previously observed behavior. Analysis of the behavior may reveal that a combination of Jane Doe+any speed, any call+traveling over 40 m.p.h., and any call while traveling in the rain all pass threshold erratic probability considerations.

Based on the observed behavior, one or more rules may be formulated 815 and suggested to the driver 817 (or suggested, for example, to a driver's parents, via text, email, etc.). In the example presented here, the rules could be that calls from Jane Doe are always blocked when driving, and all calls are blocked if the vehicle is traveling in rain or over 40 m.p.h. This can allow a driver to adaptively filter incoming calls to increase the safety of the driving experience based on the driver's own behavior in certain conditions. Since the vehicle may be in a better position that the driver to “notice” erratic driving, the vehicle can aid, using statistics and observed behavior, in rule formulation.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer-implemented method comprising:
detecting an incoming call to a wireless device in communication with a vehicle computing system (VCS);
determining that a do not disturb (DND) feature is enabled on the VCS;
comparing one or more aspects of the incoming call to one or more filters of the DND feature to determine user notification eligibility; and
conditional on the eligibility of the call, notifying the user, through the VCS, of the incoming call.

2. The method of claim 1, wherein the one or more aspects of the incoming call includes a caller phone number.

3. The method of claim 1, wherein the one or more aspects of the incoming call includes a calling party.

4. The method of claim 1, wherein at least one filter is a “block” filter.

5. The method of claim 1, wherein at least one filter is an “allow” filter.

6. The method of claim 1, further comprising:
determining that at least one filter is a conditional filter; and
conditional on the condition for filter enablement being met, utilizing the filter in the comparing.

7. The method of claim 6, wherein the condition is a weather condition at the vehicle location.

8. The method of claim 6, wherein the condition is a traffic condition at the vehicle location.

9. The method of claim 6, wherein the condition is a time of day.

10. The method of claim 6, wherein the condition is a driver state.

11. A computer implemented method comprising:
detecting an incoming call to a wireless device in communication with a vehicle computing system (VCS);
permitting hands-free answering of the call through the VCS;
evaluating driver behavior during the call;
conditional on the results of the evaluating, storing a plurality of environmental factors existent during the call;
analyzing stored environmental factors; and
resultant on the analyzing, recommending one or more rules for call filtering.

12. The method of claim 11, wherein the evaluating includes comparing aspects of a drive to baseline aspects.

13. The method of claim 12, wherein the aspects include speed.

14. The method of claim 12, wherein the aspects include drift.

15. The method of claim 12, wherein the aspects include braking force.

16. The method of claim 11, wherein the environmental factors include weather.

17. The method of claim 11, wherein the environmental factors include traffic.

18. The method of claim 11, wherein the environmental factors include time of day.

19. A computer-implemented method comprising:
transmitting vehicle GPS coordinates from a vehicle computing system (VCS) to a remote server;
receiving one or more legally required call filters from the remote server;
implementing the one or more legally required call filters in a do not disturb system;
and enabling the do not disturb system.

20. The method of claim 19, wherein the one or more legally required call filters have GPS boundaries associated therewith, wherein the method further comprises:
comparing vehicle GPS coordinates to the GPS boundaries associated with a filter; and
ignoring the filter if the vehicle GPS coordinates are not within the GPS boundaries associated with the filter.
